(19) United States
(12) Patent Application Publication
(10) Pub. No.: US 2009/0010011 A1
(43) Pub. Date: Jan. 8, 2009

(54) Solid state lighting device with heat-dissipating capability

(75) Inventors: Ching-Lin Tseng, Pan Chiao City (TW); Ming-Li Chang, Pan Chiao City (TW)

Correspondence Address: STEPTOE & JOHNSON LLP, 1330 CONNECTICUT AVENUE, N.W., WASHINGTON, DC, 20036, US

(73) Assignee: BRIGHT LED ELECTRONIC CORP., Pan Chiao City (TW)

(21) Appl. No.: 12/216,407

(22) Filed: Jul. 3, 2008

(30) Foreign Application Priority Data
Jul. 5, 2007 (TW) 096124432

(51) Int. Cl. F21V 29/00

(52) U.S. Cl. 362/373

(57) ABSTRACT

A solid state lighting device includes a heat-dissipating base, a diode chip, and a plurality of conductive terminals. The heat-dissipating base includes a base body formed integrally from a thermally conductive material. The base body has a top side, and is formed with a cavity that is indented from the top side. The base body further has a plurality of terminal channels, each of which extends from the cavity to an exterior of the base body. The diode chip is disposed in the cavity. Each of the conductive terminals extends through a respective one of the terminal channels, and has a first connecting part that is disposed in the cavity and that is coupled electrically to the diode chip, and a second connecting part that is disposed outwardly of the heat-dissipating base.

### CROSS-REFERENCE TO RELATED APPLICATION

This application claims priority of Taiwanese application no. 096124432, filed on Jul. 5, 2007.

### BACKGROUND OF THE INVENTION

1. Field of the Invention

The invention relates to a solid state lighting device, more particularly to a solid state lighting device with heat-dissipating capability.

2. Description of the Related Art

While conventional high-power light emitting diodes can produce sufficient amount of light to replace conventional light bulbs, a large amount of heat is generated when large electric currents are supplied thereto. Therefore, the issue of heat dissipation of high-power light emitting diodes is of primary concern to manufacturers.

Referring to FIG. 1, U.S. Patent Application Publication No. US 2005/0205889 A1 discloses a high-power light emitting diode (LED) package 9 that includes a substrate 91, a conductive material 94, a LED chip 96, and a lens 99. The substrate 91 is formed with a pair of electrodes 92, 93. The LED chip 96 is disposed in a trough 95 of the conductive material 94. The conductive material 94 is coupled to the bottom side of the substrate 91. The LED chip 96 has a pair of chip contacts 97, 98 connected to the electrodes 92, 93 of the substrate 91, respectively. By mounting the LED chip 96 directly in the conductive material 94, heat generated by the LED chip 96 can be quickly dissipated. Moreover, in order to avoid short-circuiting between the electrodes 92, 93 and the conductive material 94, the substrate 91 should be made of an insulator material with poor heat conducting capability.

Apart from heat conductivity of a heat dissipating material, contact area between the heat dissipating material and the surrounding environment is also an important consideration for heat dissipation. In the conventional LED package 9 of FIG. 1, although the bottom side of the conductive material 94 is able to conduct heat exchange with the surrounding environment through direct contact therewith, since the top side of the conductive material 94 is covered by the substrate 91, heat radiated upwardly from the conductive material 94 is dissipated through the substrate 91, which has poor heat conducting capability, and the electrodes 92, 93. It is apparent that the substrate 91 impedes heat dissipation from the top side of the conductive material 94, such that most of the heat can only be dissipated through the bottom side of the conductive material 94, thereby adversely affecting the overall heat dissipating efficiency of the LED package 9.

### SUMMARY OF THE INVENTION

Therefore, an object of the present invention is to provide a solid state lighting device that uses thermally conductive materials, such as metal and ceramic materials, to promote heat dissipation, and that can prevent short-circuiting of its components.

Accordingly, a solid state lighting device of the present invention comprises a heat-dissipating base, a diode chip, and a plurality of conductive terminals.

The heat-dissipating base includes a base body formed integrally from a thermally conductive material. The base body has a top side, and is formed with a cavity that is indented from the top side. The base body further has a plurality of terminal channels, each of which extends from the cavity to an exterior of the base body. The diode chip is disposed in the cavity. Each of the conductive terminals extends through a respective one of the terminal channels, and has a first connecting part that is disposed in the cavity and that is coupled electrically to the diode chip, and a second connecting part that is disposed outwardly of the heat-dissipating base.

### BRIEF DESCRIPTION OF THE DRAWINGS

Other features and advantages of the present invention will become apparent in the following detailed description of the preferred embodiments with reference to the accompanying drawings, of which:

FIG. 1 is an exploded perspective view of a conventional high-power light emitting diode package;

FIG. 2 is an exploded perspective view of the first preferred embodiment of a solid state lighting device with heat dissipating capability according to the present invention;

FIG. 3 is an assembled perspective view of the first preferred embodiment;

FIG. 4 is a sectional view of the first preferred embodiment;

FIG. 5 is an exploded perspective view of the second preferred embodiment of a solid state lighting device with heat dissipating capability according to the present invention;

FIG. 6 is an assembled perspective view of the second preferred embodiment;

FIG. 7 is a sectional view of the second preferred embodiment;

FIG. 8 is an exploded perspective view of the third preferred embodiment of a solid state lighting device with heat dissipating capability according to the present invention;

FIG. 9 is an assembled perspective view of the third preferred embodiment;

FIG. 10 is a sectional view of the third preferred embodiment;

FIG. 11 is an assembled perspective view of the fourth preferred embodiment of a solid state lighting device with heat dissipating capability according to the present invention;

FIG. 12 is an assembled sectional view of the fourth preferred embodiment;

FIG. 13 is an assembled sectional view of a modification of the fourth preferred embodiment;

FIG. 14 is an assembled sectional view of another modification of the fourth preferred embodiment; and

FIG. 15 is an assembled perspective view of the fifth preferred embodiment of a solid state lighting device with heat dissipating capability according to the present invention.

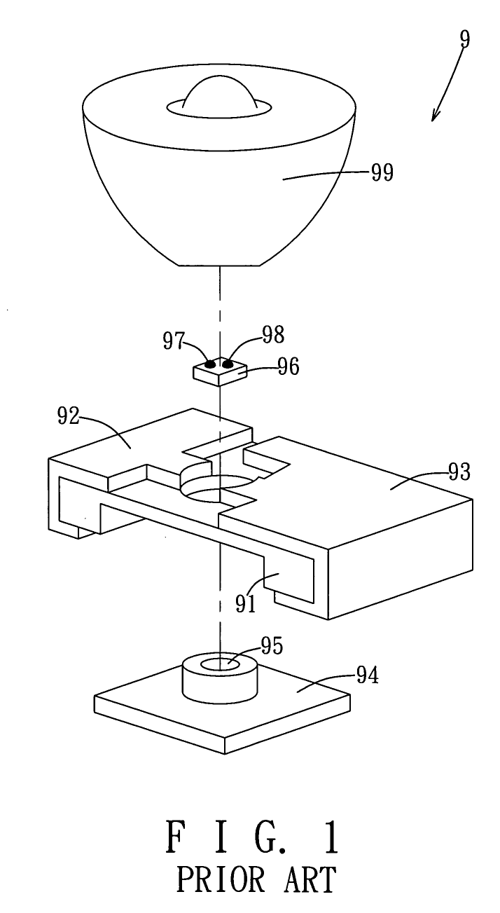

### DETAILED DESCRIPTION OF THE PREFERRED EMBODIMENTS

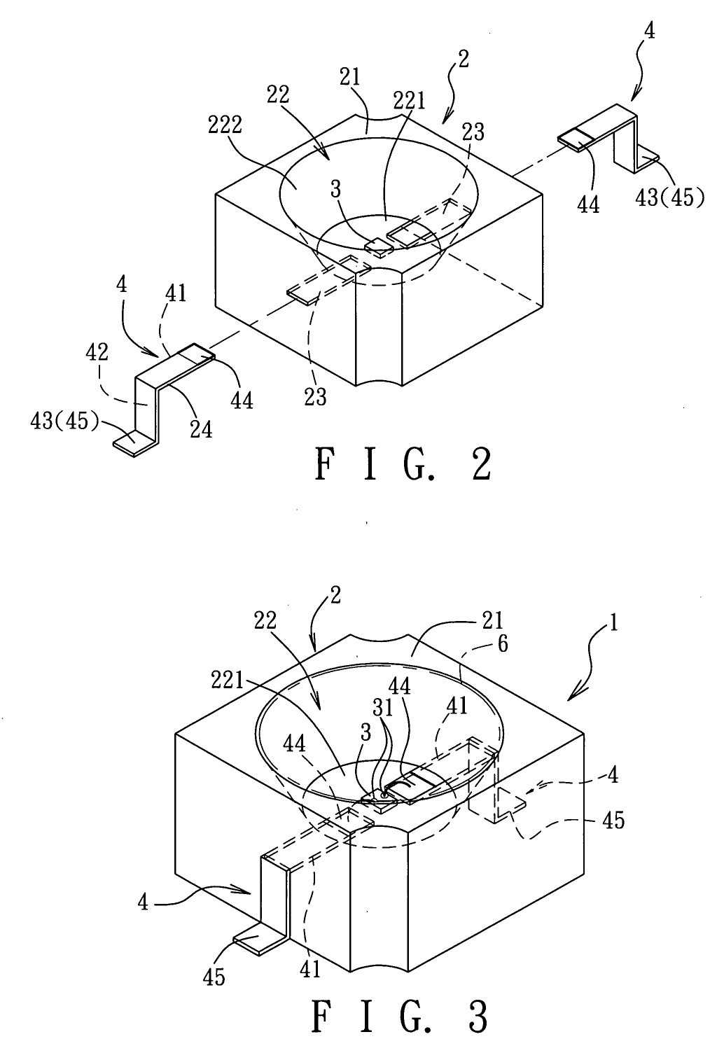

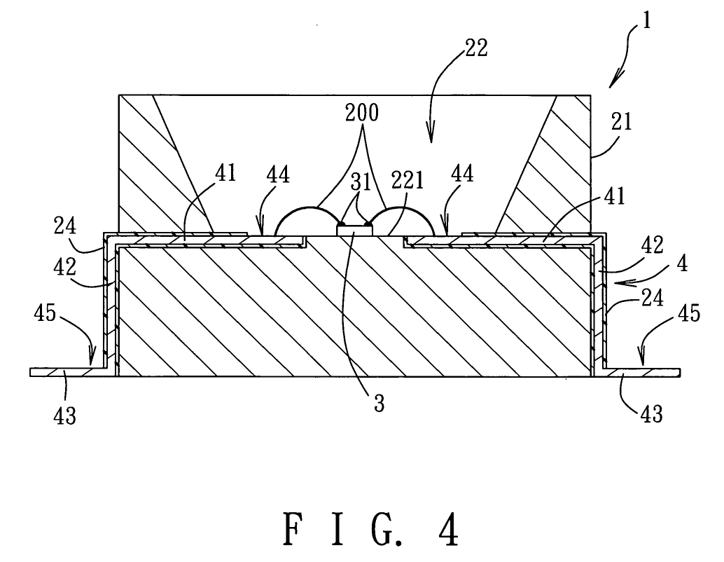

Referring to FIGS. 2 to 4, the first preferred embodiment of a solid state lighting device 1 with heat dissipating capability according to the present invention is shown to comprise a heat-dissipating base 2, a diode chip 3, a pair of conductive terminals 4, and a light-transmissible layer 6.

The heat-dissipating base 2 includes a base body 21 formed integrally from a thermally conductive material. The base body 21 has a top side, and is formed with a cavity 22 that is indented from the top side. The cavity 22 is defined by a bottom wall 221 that is spaced apart from the top side of the base body 21, and a surrounding wall 222 that extends from the bottom wall 221 to the top side of the base body 21. The bottom wall 221 and the surrounding wall 222 cooperate to define a frustoconical space to be filled by the light-transmissible layer 6. The base body 21 further has a pair of terminal channels 23, each of which extends from the cavity 22 to an exterior of the base body 21. In this embodiment, each of the terminal channels 23 has one end disposed in the cavity 22 and indented from an upper surface of the bottom wall 221, and extends from the cavity 22 to a respective one of opposite lateral outer sides of the base body 21.

In this embodiment, the base body 21 of the heat-dissipating base 2 is made of a metal material. The base body 21 may be formed by extrusion, followed by machining operations to form the cavity 22 and the terminal channels 23. Alternatively, the base body 21 may be formed directly with the cavity 22 and the terminal channels 23 by injection molding or casting techniques. The base body 21 is preferably made of copper or aluminum in this embodiment, but can be made of a silicon substrate in other embodiments of the invention.

In this embodiment, each of the conductive terminals 4 is a metal plate with good electrical conductivity, and has a first horizontal segment 41 with inner and outer ends, a vertical segment 42 extending downwardly from the outer end of the first horizontal segment 41 and having a bottom end distal from the first horizontal segment 41, a second horizontal segment 43 extending from the bottom end of the vertical segment 42 in a direction away from the first horizontal segment 41, a first connecting part 44 disposed at the first horizontal segment 41, and a second connecting part 45 disposed at the second horizontal segment 43. Each of the conductive terminals 4 is covered with the electrical insulation layer 24. In this embodiment, each conductive terminal 4 is made by punching, and the electrical insulation layer 24 is a plastic layer formed on the respective conductive terminal 4 by injection molding. The vertical segment 42 and the first horizontal segment 41 are covered with the electrical insulation layer 24. Moreover, the inner end of the first horizontal segment 41 has a top side exposed from the electrical insulation layer 24 to serve as the first connecting part 44. In this embodiment, the second horizontal segment 43 is not covered by the electrical insulation layer 24 and thus serves as the second connecting part 45.

The electrical insulation layers 24 serve to prevent the conductive terminals 4 from electrical contact with the metal heat-dissipating base 2 so as to avoid short-circuiting when the conductive terminals 4 are extended through the terminal channels 23, respectively. As such, the areas of the conductive terminals 4 to be covered with the electrical insulation layers 24 are determined by the physical contact areas of the conductive terminals 4 with the base body 21 of the heat-dissipating base 2 when the conductive terminals 4 are mounted to the heat-dissipating base 2.

Aside from plastic injection molding, the electrical insulation layer 24 may be provided on the respective conductive terminal 4 using any one of the following techniques:

1. by providing a plastic sleeve on the conductive terminal 4;

2. by covering the conductive terminal 4 with an insulating material, such as ceramic, glass fibers, etc.;

3. by subjecting areas of the conductive terminal 4 that physically contact the base body 21 to anodic surface processing so as to form an oxidized layer that serves as the electrical insulation layer 24;

4. by coating surfaces of the conductive terminal 4 with an insulating material to form the electrical insulation layer 24; and

5. by molding a resin layer on the conductive terminal 4.

The first horizontal segment 41 of each of the conductive terminals 4 is extended through the respective terminal channel 23 such that the first connecting part 44 is disposed in the cavity 22. The vertical segment 42 and the second horizontal segment 43 are disposed outwardly of the heat-dissipating base 2 so that the second connecting part 45 can be soldered to a circuit board (not shown). In this embodiment, the conductive terminals 4 are extended snugly through the terminal channels 23. In practice, glue may be applied to the conductive terminals 4 or the terminal channels 23 so as to form the electrical insulator layers 24 and so as to secure the conductive terminals 4 in the terminal channels 23.

The diode chip 3 is preferably one of a light emitting diode (LED) chip and a laser diode chip. In this embodiment, the diode chip 3 is disposed on the bottom wall 221 of the cavity 22 between the terminal channels 23. The diode chip 3 has a top surface provided with a pair of chip contacts 31, each of which is to be coupled electrically to the first connecting part 44 of a corresponding one of the conductive terminals 4 via a respective bonding wire 200.

The light-transmissible layer 6 fills the cavity 22 of the base body 21, and is made of epoxy, silicone or glass. The top portion of the light-transmissible layer 6 may be configured to have a flat surface that is flush with the top side of the base body 21, as shown in FIG. 3. When the light-transmissible layer 6 is formed by molding, the top portion thereof may be configured to be dome-shaped to result in a viewing angle ranging from 15 to 120 degrees. Moreover, the surrounding wall 222 of the cavity 22 may be provided with a reflector layer (not shown) for directing light rays emitted by the diode chip 3.

Since the solid state lighting device 1 of this invention does not utilize a substrate that can block heat dissipation, heat can be dissipated by the metal heat-dissipating base 2 in all directions (e.g., through the top side of the base body 21 and the bottom wall 221 of the cavity 22). As such, when the diode chip 3 is activated to emit light, heat generated thereby can be dissipated quickly through the base body 21. Moreover, in view of the electrical insulation layers 24 that prevent electrical contact between the conductive terminals 4 and the base body 21 of the heat-dissipating base 2, short-circuiting can be avoided.

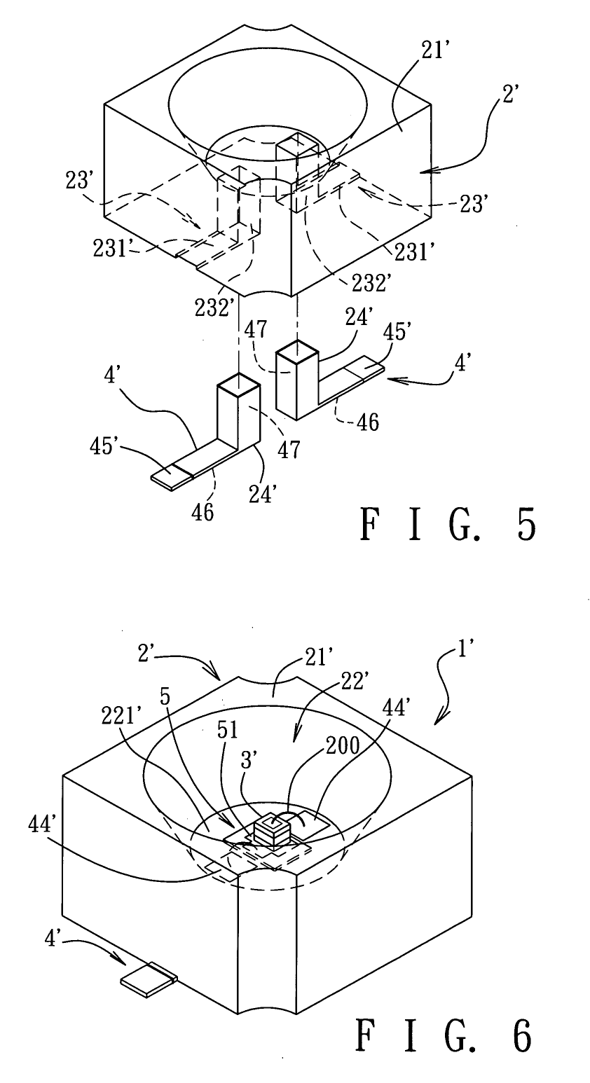

FIGS. 5 to 7 show the second preferred embodiment of the solid state lighting device 1′ according to the present invention. The solid state lighting device 1′ includes a heat-dissipating base 2′, a pair of conductive terminals 4′, a ceramic substrate 5, and a diode chip 3′ soldered onto the ceramic substrate 5. The second preferred embodiment differs from the first preferred embodiment in the configurations of the conductive terminals 4′ and the terminal channels 23′ in the base body 21′ of the heat-dissipating base 2′, and in the connections between the diode chip 3′ and the conductive terminals 4′.

In this embodiment, the base body 21′ further has a bottom side opposite to the top side, and each of the terminal channels 23′ has a horizontal section 231′ formed in the bottom side of the base body 21′ and extending to a respective one of opposite outer lateral sides of the base body 21′, and a vertical section 232′ extending from an inner end of the horizontal section 231′ to the bottom wall 221′ of the cavity 22′. Each of the horizontal sections 231′ is indented from the bottom side of the base body 21′.

Each of the conductive terminals 4′ has a horizontal segment 46 and a vertical segment 47 extending upwardly from an inner end of the horizontal segment 47. The horizontal segment 46 is disposed in the horizontal section 231′ of the respective one of the terminal channels 23′, is covered with the electrical insulation layer 24′, and has an outer end that projects outwardly of the base body 21′ and that is exposed from the electrical insulation layer 24′ to serve as the second connecting part 45′. The vertical segment 47 is disposed in the vertical section 232′ of the respective one of the terminal channels 23′, has a top end that is accessible from the bottom wall 221′ of the cavity 22′ to serve as the first connecting part 44′, and further has an outer peripheral surface that is covered with the electrical insulation layer 24′.

In this embodiment, the diode chip 3′ has top and bottom surfaces, each of which is provided with a chip contact 31′. The ceramic substrate 5 is disposed on the bottom wall 221′ of the cavity 22′ and has a top surface formed with a conductive region 51. The chip contact 31′ on the bottom surface of the diode chip 3′ is soldered onto the conductive region 51 of the ceramic substrate 5. The chip contact 31′ on the top surface of the diode chip 3′ is coupled electrically to the first connecting part 44′ of one of the conductive terminals 4′ via one of the bonding wires 200. The conductive region 51 of the ceramic substrate 5 is coupled electrically to the first connecting part 44′ of the other one of the conductive terminals 4′ via the other one of the bonding wires 200.

The thickness of the ceramic substrate 5 used in this embodiment is chosen to be as small as possible in view of heat conduction considerations. The material for the ceramic substrate 5 is preferably one having good thermal conductivity, such as aluminum nitride. The ceramic substrate 5 may be replaced by a silicon substrate with circuit tracks in other embodiments of this invention. Moreover, like the first preferred embodiment, the electrical insulation layer 24′ can be a plastic layer formed by injection molding, an oxidized layer formed by anodic surface processing, a plastic sleeve, etc.

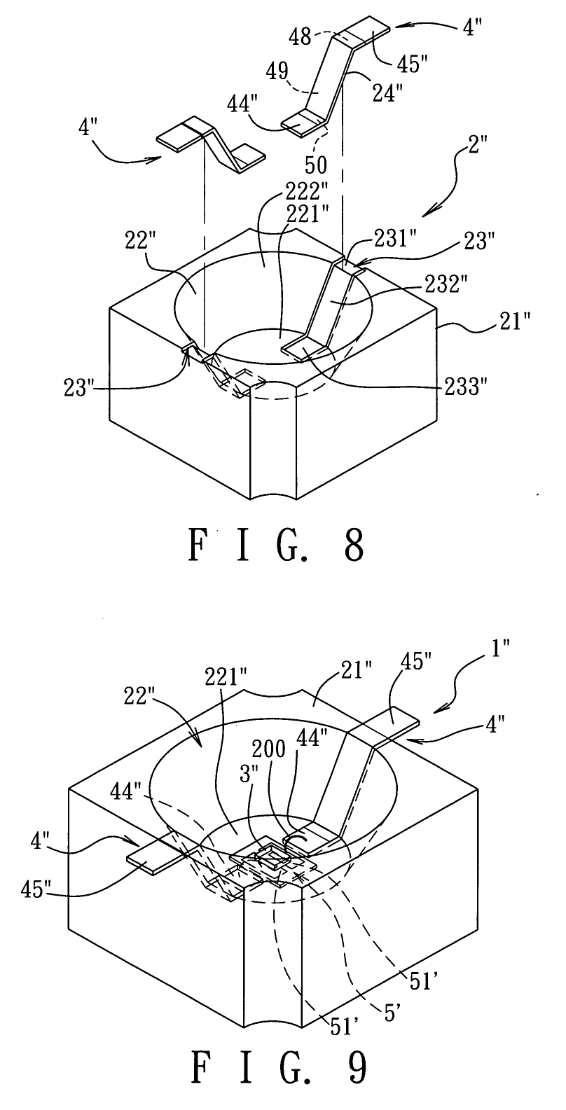

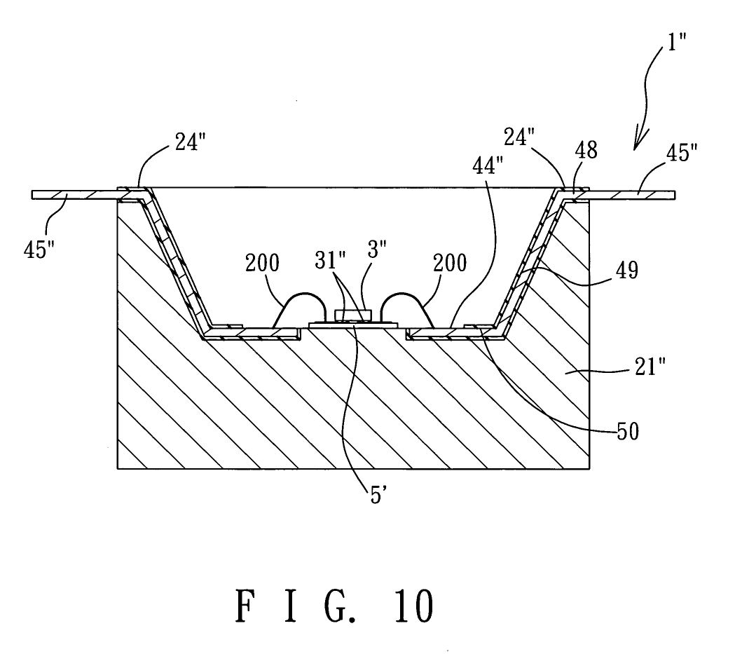

FIGS. 8 to 10 show the third preferred embodiment of the solid state lighting device 1″ according to the present invention. The solid state lighting device 1″ includes a heat-dissipating base 2″, a pair of conductive terminals 4″, a ceramic substrate 5′, and a diode chip 3″ soldered onto the ceramic substrate 5′. The third preferred embodiment differs from the second preferred embodiment in the configurations of the conductive terminals 4″ and the terminal channels 23″ in the base body 21″ of the heat-dissipating base 2″, and in the connections between the diode chip 3″ and the conductive terminals 4″.

In this embodiment, each of the terminal channels 23″ has a first horizontal section 233″ formed in the bottom wall 221″ of the cavity 22″, a second horizontal section 231″ formed in the top side of the base body 21″, and an intermediate section 232″ formed in the surrounding wall 222″ of the cavity 22″ and extending between the first horizontal section 233″ and the second horizontal section 231″.

Each of the conductive terminals 4″ has a first horizontal segment 50, an intermediate segment 49 extending obliquely and upwardly from one end of the first horizontal segment 50, and a second horizontal segment 48 extending from one end of the intermediate segment 49 opposite to the first horizontal segment 50 and extending in a direction away from the first horizontal segment 50.

The first horizontal segment 50 is retained in the first horizontal section 233″ of the respective terminal channel 23″, is covered with the electrical insulation layer 24″, and has a top side exposed from the electrical insulation layer 24″ to serve as the first connecting part 44″.

The intermediate segment 49 is retained in the intermediate section 232″ of the respective terminal channel 23″ and is covered with the electrical insulation layer 24″.

The second horizontal segment 48 is retained in the second horizontal section 231″ of the respective terminal channel 23″, is covered with the electrical insulation layer 24″, and has one end that projects outwardly of the base body 21″ and that is exposed from the electrical insulation layer 24″ to serve as the second connecting part 45″.

In this embodiment, the ceramic substrate 5′ is disposed on the bottom wall 221″ of the cavity 22″ and has a top surface formed with a pair of conductive regions 51′ separate from each other. The diode chip 3″ has a bottom surface provided with a pair of chip contacts 31″ which are soldered respectively onto the conductive regions 51′ of the ceramic substrate 5′. Each of the conductive regions 51′ is coupled electrically to the first connecting part 44″ of a corresponding one of the conductive terminals 4″ via a respective one of the bonding wires 200.

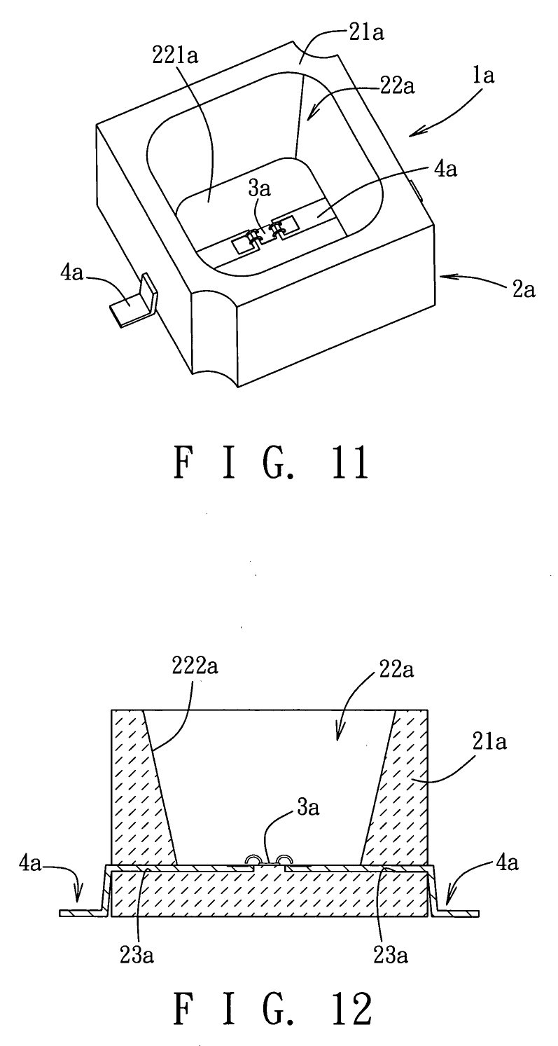

FIGS. 11 and 12 show the fourth preferred embodiment of the solid state lighting device (1a) according to the present invention. The fourth preferred embodiment differs from the previous embodiments in that the base body (21a) of the heat-dissipating base (2a) is made of a thermally conductive ceramic material, such as aluminum nitride, beryllium oxide or silicon carbide. The surrounding wall (222a) of the cavity (22a) is a rectangular wall that diverges gradually in a direction away from the bottom wall (221a). In this embodiment, because the base body (21a) is made of the thermally conductive ceramic material, there is no need to cover the conductive terminals (4a) with electrical insulation when installing the conductive terminals (4a) in the terminal channels (23a).

The base body (21a) made from the thermally conductive ceramic material according to this embodiment has a large contact area with the surrounding environment to permit fast heat dissipation.

It should be noted herein that the configurations of the terminal channels and the conductive terminals, as well as the connections between the diode chip and the conductive terminals, adopted in the second and third preferred embodiments of this invention are applicable to the fourth preferred embodiment.

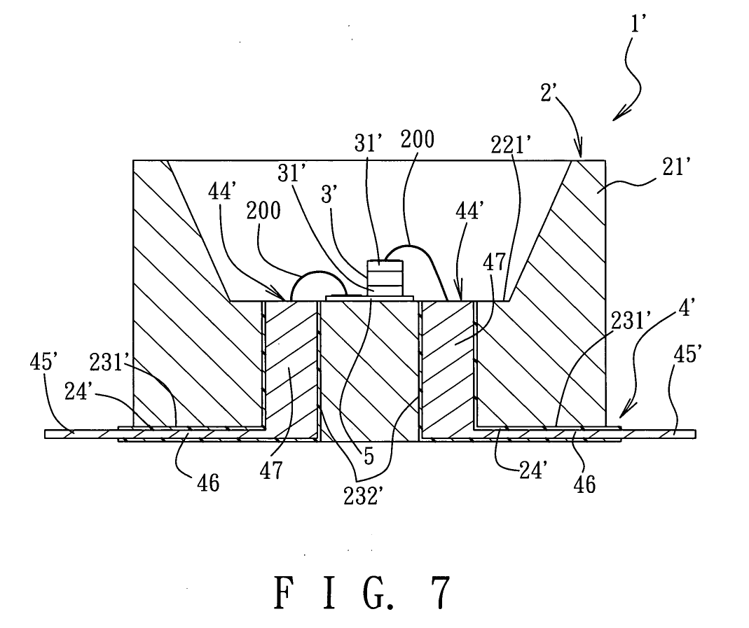

For example, referring to FIG. 13, which illustrates a possible modification of the fourth preferred embodiment, the base body (21a) of the heat-dissipating base is made of a thermally conductive ceramic material, and the diode chip (3a) is mounted directly on the bottom wall (221a) of the cavity (22a). The diode chip (3a) has top and bottom surfaces, each of which is provided with a chip contact (31a). The chip contact (31a) on the bottom surface of the diode chip (3a) is coupled electrically to one of the conductive terminals (4a) via a conductive region (51a) that is formed on the bottom wall (221a) of the cavity (22a), and a bonding wire 200 that interconnects the conductive region (51a) and the first connecting part (44a) of said one of the conductive terminals (4a). The chip contact (31a) on the top surface of the diode chip (3a) is coupled electrically to the first connecting part (44a) of the other conductive terminal (4a) via another bonding wire 200. Compared to the second preferred embodiment, the ceramic substrate 5 (see FIGS. 6 and 7) is omitted in the solid state lighting device of FIG. 13.

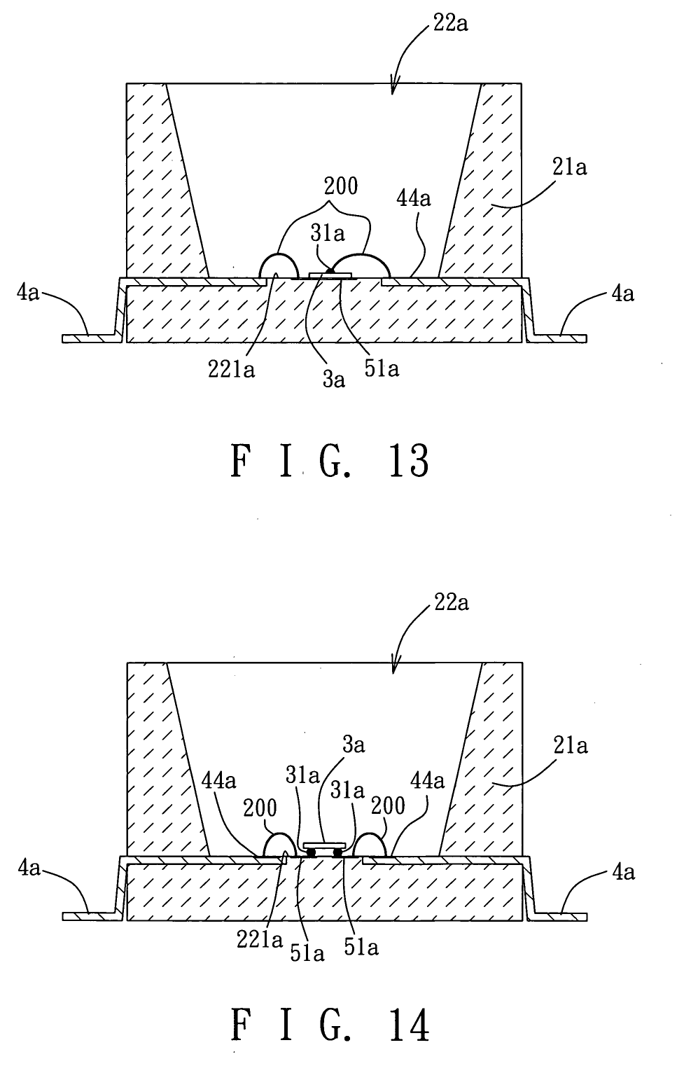

Referring to FIG. 14, which illustrates another possible modification of the fourth preferred embodiment, the base body (21a) of the heat-dissipating base is made of a thermally conductive ceramic material, and the diode chip (3a) has a bottom surface provided with a pair of chip contacts (31a). The chip contacts (31a) on the bottom surface of the diode chip (3a) are soldered directly and respectively onto a pair of conductive regions (51a) formed on the bottom wall (221a) of the cavity (22a). The conductive regions (51a) are coupled electrically and respectively to the first connecting parts (44a) of the conductive terminals (4a) via a pair of bonding wires 200.

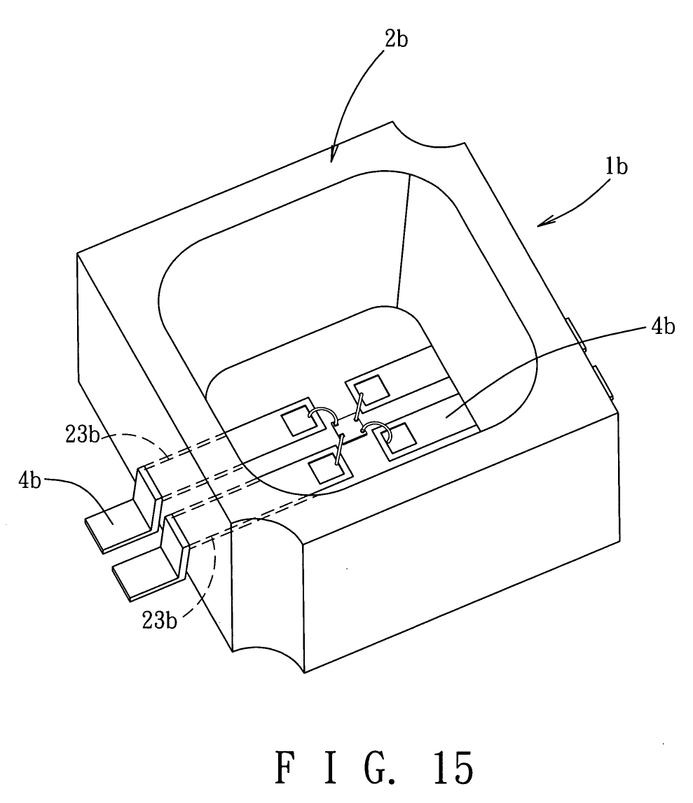

FIG. 15 shows the fifth preferred embodiment of the solid state lighting device (1b) according to the present invention. The fifth preferred embodiment differs from the previous embodiments in the number of the conductive terminals (4b). In this embodiment, there are four conductive terminals (4b), and the base body of the heat-dissipating base (2b) is formed with four terminal channels (23b) for extension of the conductive terminals (4b), respectively. In use, two of the conductive terminals (4b) on one of the lateral sides of the heat-dissipating base (2b) are grounded. The other two conductive terminals (4b) on the other one of the lateral sides of the heat-dissipating base (2b) are used to receive different input voltages, respectively.

It should be noted herein that the base body of the heat-dissipating base of the solid state lighting device of this invention may be coupled to other components, such as a heat sink or a heat-dissipating fan, with the use of fasteners to further enhance the heat dissipating effect.

In sum, by forming the base body of the heat-dissipating base integrally from a thermally conductive material, such as metal or thermally conductive ceramic, the base body can have a large contact area with the surrounding environment so that heat can be effectively exchanged therewith to enhance the heat dissipating efficiency of the solid state lighting device of this invention and to prolong the service life of the diode chip. Moreover, when the base body is made of metal, use of the electrical insulation layers can prevent electrical contact between the conductive terminals and the base body to avoid short-circuiting.

While the present invention has been described in connection with what are considered the most practical and preferred embodiments, it is understood that this invention is not limited to the disclosed embodiments but is intended to cover various arrangements included within the spirit and scope of the broadest interpretation so as to encompass all such modifications and equivalent arrangements.

What is claimed is:

1. A solid state lighting device with heat-dissipating capability, comprising:
a heat-dissipating base including a base body formed integrally from a thermally conductive material, said base body having a top side and being formed with a cavity that is indented from said top side, said base body further having a plurality of terminal channels, each of which extends from said cavity to an exterior of said base body;
at least one diode chip disposed in said cavity; and
a plurality of conductive terminals corresponding in number to said terminal channels, each of said conductive terminals extending through a respective one of said terminal channels and having a first connecting part that is disposed in said cavity and that is coupled electrically to said diode chip, and a second connecting part that is disposed outwardly of said heat-dissipating base.

2. The solid state lighting device as claimed in claim 1, wherein said base body is made of one of a metal material and a silicon substrate, each of said conductive terminals being covered with an electrical insulation layer, said first and second connecting parts of each of said conductive terminals being exposed from said electrical insulation layer.

3. The solid state lighting device as claimed in claim 2, wherein each of said conductive terminals has a first horizontal segment that extends into the respective one of said terminal channels and that is covered with said electrical insulation layer, said first horizontal segment having an inner end extending into said cavity, said inner end of said first horizontal segment having a top side exposed from said electrical insulation layer to serve as said first connecting part.

4. The solid state lighting device as claimed in claim 3, wherein said base body has opposite lateral outer sides, each of said terminal channels extending from said cavity to one of said lateral outer sides of said base body, said first horizontal segment of each of said conductive terminals further having an outer end opposite to said inner end, each of said conductive terminals further having
a vertical segment extending downwardly from said outer end of said first horizontal segment and disposed outwardly of said base body, said vertical segment having a bottom end distal from said first horizontal segment, and
a second horizontal segment extending from said bottom end of said vertical segment in a direction away from said first horizontal segment, said second connecting part being disposed at said second horizontal segment.

5. The solid state lighting device as claimed in claim 4, wherein said vertical segment of each of said conductive terminals is covered with said electrical insulation layer.

6. The solid state lighting device as claimed in claim 2, wherein said cavity is defined by a bottom wall that is spaced apart from said top side of said base body, and a surrounding wall that extends from said bottom wall to said top side of said base body.

7. The solid state lighting device as claimed in claim 6, wherein said base body further has a bottom side opposite to said top side, each of said terminal channels having a horizontal section formed in said bottom side of said base body, and a vertical section extending from said horizontal section to said bottom wall of said cavity, each of said conductive terminals having a horizontal segment and a vertical segment extending from said horizontal segment,
said horizontal segment being disposed in said horizontal section of the respective one of said terminal channels, being covered with said electrical insulation layer, and having one end that projects outwardly of said base body and that is exposed from said electrical insulation layer to serve as said second connecting part,
said vertical segment being disposed in said vertical section of the respective one of said terminal channels, having a top end that is accessible from said bottom wall of said cavity to serve as said first connecting part, and further having an outer peripheral surface that is covered with said electrical insulation layer.

8. The solid state lighting device as claimed in claim 6, wherein each of said terminal channels has a first horizontal section formed in said bottom wall of said cavity, a second horizontal section formed in said top side of said base body, and an intermediate section extending between said first horizontal section and said second horizontal section,
each of said conductive terminals having a first horizontal segment, an intermediate segment extending from said first horizontal segment, and a second horizontal segment extending from one end of said intermediate segment opposite to said first horizontal segment and extending in a direction away from said first horizontal segment,
said first horizontal segment being retained in said first horizontal section of the respective one of said terminal channels, being covered with said electrical insulation layer, and having a top side exposed from said electrical insulation layer to serve as said first connecting part,
said intermediate segment being retained in said intermediate section of the respective one of said terminal channels and being covered with said electrical insulation layer,
said second horizontal segment being retained in said second horizontal section of the respective one of said terminal channels, being covered with said electrical insulation layer, and having one end that projects outwardly of said base body and that is exposed from said electrical insulation layer to serve as said second connecting part.

9. The solid state lighting device as claimed in claim 2, wherein said electrical insulation layer is a plastic layer formed on each of said conductive terminals by injection molding.

10. The solid state lighting device as claimed in claim 2, wherein said electrical insulation layer is an oxidized layer formed by subjecting each of said conductive terminals to anodic surface processing.

11. The solid state lighting device as claimed in claim 2, wherein said electrical insulation layer is a resin layer formed on each of said conductive terminals by molding.

12. The solid state lighting device as claimed in claim 2, wherein said base body is made of one of copper and aluminum.

13. The solid state lighting device as claimed in claim 1, wherein said base body is made of a thermally conductive ceramic material.

14. The solid state lighting device as claimed in claim 13, wherein said base body is made of a material selected from the group of aluminum nitride, beryllium oxide and silicon carbide.

15. The solid state lighting device as claimed in claim 6, further comprising a plurality of bonding wires corresponding in number to said conductive terminals, said diode chip being disposed on said bottom wall of said cavity and having a top surface provided with a plurality of chip contacts, each of which is coupled electrically to said first connecting part of a corresponding one of said conductive terminals via a respective one of said bonding wires.

16. The solid state lighting device as claimed in claim 6, further comprising a ceramic substrate and a plurality of bonding wires corresponding in number to said conductive terminals, said ceramic substrate being disposed on said bottom wall of said cavity and having a top surface formed with a conductive region, said diode chip having top and bottom surfaces, each of which is provided with a chip contact,
said chip contact on said bottom surface of said diode chip being soldered onto said conductive region of said ceramic substrate,
said chip contact on said top surface of said diode chip being coupled electrically to said first connecting parts of a portion of said conductive terminals via a portion of said bonding wires,
said conductive region of said ceramic substrate being coupled electrically to said first connecting parts of another portion of said conductive terminals via another portion of said bonding wires.

17. The solid state lighting device as claimed in claim 6, further comprising a ceramic substrate and a plurality of bonding wires corresponding in number to said conductive terminals, said ceramic substrate being disposed on said bottom wall of said cavity and having a top surface formed with a pair of conductive regions separate from each other, said diode chip having a bottom surface provided with a pair of chip contacts, said chip contacts being soldered respectively onto said conductive regions of said ceramic substrate, said conductive regions being coupled electrically to said first connecting parts of said conductive terminals via said bonding wires.

18. The solid state lighting device as claimed in claim 13, further comprising a plurality of bonding wires corresponding in number to said conductive terminals, said diode chip having a top surface provided with a plurality of chip contacts, each of which is coupled electrically to said first connecting part of a corresponding one of said conductive terminals via a respective one of said bonding wires.

19. The solid state lighting device as claimed in claim 13, further comprising a ceramic substrate and a plurality of bonding wires corresponding in number to said conductive terminals, said ceramic substrate being disposed in said cavity and having a top surface formed with a conductive region, said diode chip having top and bottom surfaces, each of which is provided with a chip contact,
said chip contact on said bottom surface of said diode chip being soldered onto said conductive region of said ceramic substrate,
said chip contact on said top surface of said diode chip being coupled electrically to said first connecting parts of a portion of said conductive terminals via a portion of said bonding wires,
said conductive region of said ceramic substrate being coupled electrically to said first connecting parts of another portion of said conductive terminals via another portion of said bonding wires.

20. The solid state lighting device as claimed in claim 13, further comprising a ceramic substrate and a plurality of bonding wires corresponding in number to said conductive terminals, said ceramic substrate being disposed in said cavity and having a top surface formed with a pair of conductive regions separate from each other, said diode chip having a bottom surface provided with a pair of chip contacts, said chip contacts being soldered respectively onto said conductive regions of said ceramic substrate, said conductive regions being coupled electrically to said first connecting parts of said conductive terminals via said bonding wires.

21. The solid state lighting device as claimed in claim 13, further comprising a plurality of bonding wires corresponding in number to said conductive terminals, said cavity being defined by a bottom wall that is spaced apart from said top side of said base body and that is formed with a conductive region, said diode chip having top and bottom surfaces, each of which is provided with a chip contact,
said chip contact on said bottom surface of said diode chip being soldered onto said conductive region,
said chip contact on said top surface of said diode chip being coupled electrically to said first connecting parts of a portion of said conductive terminals via a portion of said bonding wires,
said conductive region being coupled electrically to said first connecting parts of another portion of said conductive terminals via another portion of said bonding wires.

22. The solid state lighting device as claimed in claim 13, further comprising a plurality of bonding wires corresponding in number to said conductive terminals, said cavity being defined by a bottom wall that is spaced apart from said top side of said base body and that is formed with a pair of conductive regions separate from each other, said diode chip having a bottom surface provided with a pair of chip contacts, said chip contacts being soldered respectively onto said conductive regions, said conductive regions being coupled electrically to said first connecting parts of said conductive terminals via said bonding wires.

23. The solid state lighting device as claimed in claim 1, further comprising a light-transmissible layer that fills said cavity.
